(19) United States
(12) Patent Application Publication
(10) Pub. No.: US 2025/0113843 A1
(43) Pub. Date: Apr. 10, 2025

(54) CELLULOSIC POLYMER-COATED GRANULES

(71) Applicant: Eastman Chemical Company, Kingsport, TN (US)

(72) Inventors: Thomas Luc Rottiers, Denderleeuw (BE); Kristof Moonen, Hamme (BE); Nicholas Michael Martyak, Johnson City, TN (US); Ying Chen, San Diego, CA (US); Devin G. Barrett, Alpharetta, GA (US)

(73) Assignee: Eastman Chemical Company, Kingsport, TN (US)

(21) Appl. No.: 18/730,121

(22) PCT Filed: Jan. 13, 2023
(86) PCT No.: PCT/US2023/060621

§ 371 Date: Jul. 18, 2024

Related U.S. Application Data
(60) Provisional application No. 63/266,872, filed on Jan. 18, 2022.

(51) Int. Cl. A23K 40/10; A23K 20/158; A23K 40/35; A23K 50/10

(52) U.S. Cl. CPC A23K 40/10; A23K 20/158; A23K 40/35; A23K 50/10

(57) ABSTRACT

The present application discloses granules with a solid core that is coated with a cellulosic polymer. The solid core of the granules can be made of a number of active ingredients. The granules can be used in animal feeds to deliver the active ingredients into the intestine of animals for maximum effect.

### BACKGROUND OF THE INVENTION

The preferred target for delivery of active ingredients useful in production animal feeds is typically in the gastrointestinal tract. For example, it is important to deliver small chain fatty acids (“SCFA”) such as butyrate to the distal portion of the monogastric gastrointestinal tract where colonocytes can use the SCFA as an energy source and control the proliferation of pathogenic bacteria. For SCFA salts, the most popular coating is a lipid such as hydrogenated soybean, rapeseed, palm or cottonseed oils. The lipid coated SCFA is then incorporated into feed and when eaten by the monogastric animal, the SCFA is slowly released along the gastrointestinal tract.

The release of the SCFA in the lipid coated SCFA salt is partially dependent upon lipase enzymes acting on the lipids. As the lipid coated SCFA salt travels through the gastrointestinal tract (GIT), the lipase enzymes slowly dissolve the lipid coating. The thickness of the lipid layer determines where the SCFA is released; the preference being in the colon rather than in the stomach or small intestine. The release of a SCFA salt from a lipid coating may also be affected by the mechanical action of certain segments of the gastrointestinal tract, notably the gizzard in poultry. The muscular contraction of the gizzard and the interaction of feed and other particles in the gizzard can compromise the integrity of the lipid coating thus prematurely releasing the SCFA salt.

It is common practice to pelletize production animal feed. Pelleting of the feed is done to achieve higher feed intake, avoid segregation of important feed ingredients and minimize feed loss. In addition, a high-quality feed pellet may increase the animal's growth performance. However, lipid-coated active ingredients may also be susceptible to thermal degradation during feed pelleting. Most lipid coatings have a melting point between 65° C. to 70° C. The temperature during pelleting of feed may reach between 80° to 85° C., thus possibly degrading some or all the lipid coating compromising the quality of the active ingredient, such as SCFA and SCFA salts.

Choline is essential in dairy cows and insufficient absorption may lead to health issues. To ensure some part of added choline to the diets of dairy cows is absorbed, it is common to protect the choline salt with a fat layer coating. This fat-coated choline product is commonly referred to as rumen-protected choline (RPC). RPC is a used to prevent fatty liver syndrome and ketosis (Cooke, R. F., et al., J Dairy Sci. 2007 May; 90 (5): 2413-8). RPC is also used to improve milk production and milk composition in dairy cows (Erdman, R. A., and Sharma, B. K., J Dairy Sci. 1991 May; 74 (5): 1641-7). Because the bacterial decomposition of fiber products in the rumen is slow, feed may remain in the rumen for up to forty-eight hours, which could result in significant degradation of the RPC.

Similar to choline, L-carnitine is also required by lactating dairy cows to support energy requirements. L-carnitine is endogenously synthesized and is critical for the initial step of fatty acid beta-oxidation, but with the onset of lactation it is also excreted with milk, whereby its availability for other metabolic pathways might be limited. Supplemental L-carnitine may be able to enhance the efficiency of beta-oxidation of fatty acids if it is absorbed pass the rumen. Rumen-protected L-carnitine using a fat coating is commonplace but again the fat layer is susceptible to rumen degradation.

Therefore, there is a need for new and improved coatings for effective delivery of active compound (e.g., SCFA, choline, L-carnitine) in the gastrointestinal track of animals

### SUMMARY OF THE INVENTION

The present application discloses a granule comprising: (a) an outer layer comprising a cellulosic polymer; and (b) a solid core, comprising an active ingredient, wherein the granule has a diameter of from 50 microns to 1500 microns.

The present application also discloses compositions such as animal feeds comprising the granules.

### DETAILED DESCRIPTION OF THE INVENTION

The term “acceptable carriers and excipients” is intended to mean substances, which are substantially harmless to the subject to which the composition will be administered. Excipients normally fulfil the requirements given by the national drug agencies and/or Pharmacopeia and the European Pharmacopeia set standards for well-known pharmaceutically acceptable excipients. Examples of carriers include corn cob, silica, clays (silicates), silica gel, diatomaceous earth, bentonite and kaolinite.

“An animal” characterizes an animal, including a human, in need of an active ingredient provided by the granules. The animal may further be characterized by having or being prone to poor development of the GIT, specifically the small intestine. Signs of poor development of the small intestine include presence of adverse changes in intestinal morphology, including reduced villus height (villus atrophy), increased villus width withe edema, increased crypt dept and reduced absorptive capacity and brush border enzyme activity. The animal may also be characterized by being in growth phase, such as a young animal before being fully matured as an adult animal. Some examples of animals of interest include pig, poultry such as broiler and layer chickens, fish and the dairy cows.

“Small intestine” includes the duodenum, proximal jejunum, middle jejunum, distale jejunum and ileum.

“Large intestine” includes the ceca, colon and rectum.

“Granule” means a pellet, granule, or bead. The granule may be spherical or non-spherical in nature. The granule comprises a solid core and an outer layer. The outer layer may be made up of one or more layers. The granule may optionally include an intermediate layer disposed between the outer layer and the core. The intermediate layer is made up of a material that is different than the outer layer. The core comprises at least one active ingredient. The core may include acceptable carriers and excipients.

“Acceptable salt” means a salt that is capable of being used in the solid core of the granules and can be used in animals without being harmful. Examples include salts with the following made from alkali, alkaline earth and transition metal cations, including sodium, potassium calcium, magnesium, copper, zinc, and the like. The cations can also include for example, ammonium cations. Salts with the following anions, including chloride, sulfate, acetate, propionate, butyrate, citrate, lactate, tartrate, and the like.

“Solid Core” means a matrix formed by dry, melt or wet granulation or by blending of acceptable carriers and excipients along with the active ingredient.

The solid core may further comprise diluents, binders, disintegrants, wetting agents, lubricants, glidants, flow aids, and/or flavors.

Examples of diluents include lactose, starches, mannitol, sorbitol, xylitol, dextrose, phosphates, sucrose, calcium sulfate, calcium lactate, dextrates, inositol, celluloses, calcium carbonate, glycine, bentonite, polyvinylpyrrolidone, or mixtures thereof.

Examples of disintegrants include starches, clays, celluloses, corscarmellose sodium, alginates, crospovidone, gums, or mixtures thereof.

Examples of wetting agents include quaternary ammonium compounds, phenyl ethers, polyoxyethylene fatty acid/stearates/glycerides and oils, sorbitan esters, propylene glycol fatty acid esters, glyceryl fatty acid esters or mixtures thereof.

Examples of lubricants, glidants or flow aids include glyceryl behapate, stearic acid and salts thereof, including magnesium calcium and sodium stearates, hydrogenated vegetable oils, colloidal silica, talc, waxes, boric acid, sodium benzoate, sodium acetate, sodium fumarate, sodium chloride, leucine, polyethylene glycols, sodium oleate, sodium lauryl sulfate, and magnesium lauryl sulfate, stabilizers such as desiccating amorphous silica or mixtures thereof.

Examples of binders include acacia gum, tragacanth, sucrose, gelatin, glucose, starches, pregelatinized starches, celluloses including methylcellulose and sodium carboxymethylcellulose, alginic acid and salts of alginic acid, magnesium aluminum silicate, polyethylene glycol, guar gum, polysaccharides, bentonites, polyvinylpyrrolidone, polymethacrylates, hydroxypropylmethyl cellulose, hydroxypropyl cellulose, ethyl cellulose, or mixtures thereof.

The active ingredient can be organic acids, and their salts, mono, di, tri, or poly-esters, enzymes, amino acids, amine derivatives, methylated glycine derivatives, synthetic or natural antioxidants phenolic or nonphenolic antioxidants, pigments or colorants, essential oils containing terpenes, vitamins, trace minerals, alpha or beta unsaturated compounds, organic osmolytes, alcohols, aldehydes, metal oxides, or mixtures thereof.

Organic acids can be straight-chain organic acids, hydroxy-organic acids, branched organic acids, di-, tri- or polycarboxylic acids, salts of the organic acids, or mixtures thereof.

Examples of straight-chain organic acids include short (C₁₋₅) chain, medium (C₆₋₁₄) chain and long (C₁₅₋₂₄) chain acids including formic, acetic, propionic, butyric, valeric, caproic, sorbic, caprylic, pelargonic, capric, lauric, myristic, palmitic, stearic, linoleic, linolenic and icosanoic among others.

Examples of hydroxy organic acids include alpha and beta polyhydroxy acids such as glycolic, lactic, 3-hydroxybutyric, ricinoleic and mandelic acids.

Examples of branched organic acids include isobutyric, and isovaleric and 2-ethylhexanoic acid.

Examples of di, tri and polycarboxylic acids include malonic, glutaric, succinic, itaconic, malic, tartaric, fumaric, sebacic, dodecanedioic, citric and 1,2,3,4-butane tetracarboxylic acids.

Examples of aromatic acids include benzoic acid, 2-hydroxybenzoic acid (salicylic acid), m-hydroxybenzoic, p-hydroxybenzoic, 1,2-benzenedicarboxylic acid (phthalic acid), 1,4-benzenedicarboxylic acid (terephthalic acid) among others.

An example of a cyclohexene carboxylic acid is shikimic acid.

The salts of the organic acid can be sodium, calcium, magnesium, copper, ammonium, zinc or potassium salts.

Examples of esters include mono, di and triesters alone or mixtures of mono, di and triesters with the acid groups varying from C₁₋₁₈ and the alcohol groups varying from C₁₋₁₈. The acid moieties may be linear, branched, hydroxylated, epoxidized. The alcohol moieties may be linear or branched. Examples of alcohols include C1-C18 alcohols (linear or branched), 1,2-propane diol, 1,3-propanediol, dihydroxyacetone, glycerol, diglycerol, triglycerol, polyglycerol, erythritol, threitol.

Examples of enzymes include carbohydrases, alpha galactosidase, beta-galactosidases glucanases including alpha-glucanases and beta-glucanases, beta-mannanase, proteases, amylases, xylanases, lipases, cellulases, pectinase and phytases. The enzymes may or may not be coated if they are sensitive to heat and moisture.

Examples of amino acids include essential and non-essential amino acids, nonproteinogenic amino acids and non-alpha amino acids. Examples of essential and nonessential amino acids include isoleucine, leucine, valine, histidine, lysine, methionine, phenylalanine, threonine, tryptophan, asparagine, aspartic acid or aspartate, alanine, arginine, cysteine or cystine, glutamine, glutamic acid or glutamate, glycine, proline, serine and tyrosine. Examples of nonproteinogenic amino acids include citrulline, hydroxyproline or oxoproline, selenocysteine, homocysteine, theanine and ornithine. Examples of non-alpha amino acids include β-alanine, gamma amino butyric acid (GABA), δ-aminolevulinic acid and 4-aminobenzoic acid (PABA).

Examples of amine derivatives include L-carnitine and carnitine derivatives including acetyl-L-carnitine, and propionyl-L-carnitine.

Examples of methylated glycine derivatives include choline or choline salts such as choline chloride, choline hydroxide or choline sulfate, betaine or betaine salts such as betaine hydrochloride, dimethylglycine or its salts such as sodium dimethylglycine and sarcosine and its salts such as sodium sarcosinate.

Examples of phenolic antioxidants include synthetic antioxidants, and natural antioxidants. Examples of synthetic antioxidants include butylated hydroxyanisole (BHA), butylated hydroxytoluene (BHT), gallate esters including C1-C14 esters such as propyl gallate (PG) and octyl gallate (OG) and tert-butyl hydroquinone (TBHQ), hydroquinone, catechol and resorcinol. Examples of natural antioxidants include cyclohexene carboxylic acids, hydroxycinnamic acid derivatives, phenylacetic acid derivatives, flavanoids, stilbenes, courmarins, lignans, tannins, and plant extracts.

Examples of natural phenolic acids antioxidants include hydroxybenzoic acid derivatives including gallic acid, o-, m-, and p-hydroxybenzoic acid, vanillic acid, syringic acid, protocatechuic acid and ellagic acid. Examples of natural hydroxycinnamic acid antioxidants include o-, m- and p-courmaric acid, caffeic acod, ferulic acid, diferulic acid, sinapic acid, 2,3-dihydroxycinnamic acid, 2,5-dihydroxycinnamic acid, 3,5-dihydroxycinnamic acid, 2,4,5-trihydroxycinnamic acid, umbellic acid, chicoric acid and chlorogenic acid, their esters and glycosides.

Phenylacetic acid derivatives including 3-hydroxyphenylacetic acid, 4-hydroxyphenylacetic acid, 3,4-dihydroxyphenylacetic acid, homoisovanillic acid, homovanillic acid, 4-hydroxy-3,5-dimethoxyphenylacetic acid.

Examples of flavanoids including flavonols, flavononols, flavones, flavanols (catechin), flavanones, anthocyanidins and isoflavonoids. The flavonols include quercetin, kaempferol and isorhamnetin. The flavones include apigenin, chrysin, luteolin and rutin. The flavanols (catechins) include (+)-catechin, (−)-epicatechin, (−)-epicatechin-3-gallate, (+)-gallocatechin, (−)-epigallocatechin and (−)-epigallocatechin-3-gallate. The flavanones include eriodictyol, naringenin and morin. The anthocyanidins include cyanidin, leucocyanidin, delphinidin, prodelphinidin, leucodelphinidin and propelargonidin. The isoflavonoids include genistein, daidzein, glycitein and formononetin.

An example of a stilbene is resveratrol.

Examples of tannins include hydrolyzable tannins (e.g., ellagitannins and gallotannins) and condensed tannins (e.g., proanthocyanidins).

Examples of plant extracts include those from turmeric, green tea, rosemary, oregano, basil and thyme. Examples also include ascorbic acid, rosmarinic acid, rosmanol, carnosol, carnosic acid, ruercetin, rutin, tyrosol, hydroxytyrosol and curcumin.

Example of nonphenolic antioxidant include ethoxyquin.

Examples of natural pigments or colorants includes carotenoids such as carotenes, xanthophylls. Carotenes include α-carotene, β-carotene, γ-carotene and δ-carotene. Xanthophylls include lutein, zeaxanthin, neoxanthin, violaxanthin, flavoxanthin, and α- and β-cryptoxanthin.

Examples of synthetic pigments include canthaxanthin and beta-apo-8′-carotenoic acid ethyl ester (apo-ester).

Examples of essential oils include those with terpene building blocks. Within the context of the invention, the term “terpene” refers to organic compounds construed of multiples of the 5-carbon hydrocarbon isoprene unit, or 2-methyl-1,3-butadiene, and derivatives thereof. Terpenes containing two isoprene unites are called monoterpenes, those containing three such units are sesquiterpenes, and those having four isoprene unites are diterpenes. Additionally, higher order terpenes exist and there is not upper limit to how many isoprene unites a terpene may include. Within the context of the invention, the term “terpene” also includes derivatives generally referred to as “terpenoids”, which are saturated or partially unsaturated isomers of regular terpenes as well as derivatives such as alcohols, ketones, aldehydes, esters, etc. The monoterpene according to the present invention can either be a cyclic or an acyclic monoterpene. Cyclic monoterpenes include monocyclic, bicyclic or tricyclic monoterpenes. The monoterpene in the composition according to the present invention may be a monocyclic monoterpene, a bicyclic monoterpene or an acyclic monoterpene.

The monoterpene can be an acyclic monoterpene selected from the group consisting of β-citronellol, citronellyl acetate, citral dimethyl acetal, (−)-citronellal, (+)-citronellal, (−)-β-citronellol, citronellic acid, citral (cis- or trans-), 2,6-dimethyloctane, 3,7-dimethyl-1-octanol, dihydrolinalool, (+)-dehydrolinalool, (−)-dehydrolinalool, geraniol, geranyl acetate, geranyl formate, geranylacetone ((E)- or (Z)-), geranyl nitrile, geranyl tiglate, linalool, linalyl acetate, linalyl propionate, linalyl butyrate, myrcene, nerol, neryl acetate, ocimene or mixtures thereof.

The monoterpene is a cyclic monoterpene selected from the group consisting of (−)-menthyl acetate, (+)-camphoric acid, cantharidin, carvacrol, p-cymene, (R)-(−)-carvone, (S)-(+)-carvone, cis-(−)-carveol, m-cymene, o-cymene, (1S,3R)-(−)-camphoric acid, ethyl chrysanthemate, N-ethyl-p-menthane-3-carboxamide, hinokitiol, cuminaldehyde, cis-1-isopropyl-4-methylcyclohexane, dehydroxylinalool oxide, L-menthyl glyoxylate hydrate, L-menthyl L-lactate, (+)-limonene, (−)-limonene, linalool oxide, (−)-α-phellandrene, α-terpinene, γ-terpinene, terpinen-4-ol, α-terpineol, β-terpineol, γ-terpineol, isopulegol, (+)-menthol, (−)-menthol, thymol, (−)-menthone, (−)-menthol, (−)-menthoxyacetyl chloride, menthoxyacetic acid, (−)-menthyl chloride, (−)-menthyl chloroformate, (1R,2S,5R)-(−)-menthyl(S)-p-toluenesulfinate, (1S,2R,5S)-(+)-menthyl (R)-p-toluenesulfinate, (+)-menthyl chloroformate, 8-mercaptomenthone, (−)-menthyl succinate, (+)-menthyl acetate, (+)-neomenthol, (−)-perillaldehyde, piperitone, (+)-pulegone, α-terpineol, terpinyl acetate, terpinolene, α-terpineol, terpin monohydrate, (+)-terpinen-4-ol, linalool oxide pyranoid, borneyl acetate, (+)-3-bromocamphor, (+)-borneol, (−)-borneol, (+)-3-bromocamphor-8-sulfonic acid, (−)-3-bromocamphor-8-sulfonic acid, (+)-camphene, (−)-camphene, (+)-camphor, (−)-camphor, (1R)-camphor oxime, (+)-camphorquinone, (−)-camphorquinone, (+)-10-camphorsulfuric acid, (+)-10-camphorsulfuric acid, (−)-10-camphorsulfuric acid, sodium (+)-10-camphorsulfonate, sodium (−)-10-camphorsulfonate, (+)-3-carene, 1,8-cineole, (−)-10-camphosulfuric aid, (+)-10-camphorsulfonyl chloride, (−)-camphanic acid, (−)-camphanic chloride, (−)-camphor, (−)-10-camphosulfonyl chloride, (+)-10,2-camphorsultam, (−)-10,2-camphorsultam, (2R,8aS)-(+)-(camphorylsulfonyl) oxaziridine, (2S,8aR)-(−)-(camphorylsulfonyl) oxaziridine, (+)-10-camphorsulfonimine, (−)-10-camphorsulfonimine, (1R)-(−)-camphorquinone, (1S)-(+)-camphorquinone, anti-(1R)-(+)-camphorquinone 3-oxime, 1,4-cineole, (+)-3,9-dibromocamphor, eugenol, isoeugenol, (+)-fenchone, (−)-fenchone, fraxinellone, geniposide, genipin, (1R,2R,5R)-(+)-2-hydroxy-3-pinanone, (1S,2S,5S)-(−)-2-hydroxy-3-pinanone, (+)-isoborneol, (−)-isoborneol, isobornyl acetate, isobornyl methacrylate, isobornyl acrylate, (S)-(+)-ketopinic acid, (1S)-(−)-10-mercaptoisoborneol, (1S)-(−)-10-mercaptoborneol, (1R)-(−)-myrtenal, (1R)-(−)-myrtenal, (1S)-(−)-α-pinene, (−)-β-pinene, (1R)-(+)-α-pinene, pinene oxide (α- or β-), paeoniflorin, (1S,2S,3R,5S)-(+)-2,3-pinanediol, sabinene, swertiamarin, thujone (α- or β-), (1R)-(−)-thiocamphor, (1R,4R,5R)-4,7,7-trimethyl-6-thiabicyclo[3.2.1.]octane, (1 S,4S,5S)-4,7,7-trimethyl-6-thiabicyclo[3.2.1.]octane, verbenone, or mixtures thereof.

The monoterpenes can be those known antimicrobial properties and which are generally used in the food and feed industry such as (+)-borneol, (−)-borneol, carvacrol, (R)-(−)-carvone, 1,8-cineole, eugenol, isoeugenol, (−)-menthol, (+)-menthol, (+)-terpinen-4-ol (1R)-(−)-myrtenal, (1R)-(−)-myrtenal, (1 S)-(−)-α-pinene, (1R)-(+)-α-pinene, linalool oxide, limonene, limonene oxide, α-pinene oxide, β-pinene oxide, (+)-3-carene, cis-(−)-carveol, (+)-camphor, (−)-camphor, terpinen-4-ol, thymol, terpineol (α-, β- or γ-), or a mixture thereof. Most preferred monoterpenes are thymol, carvacrol, eugenol, isoeugenol or a mixture thereof.

Examples of vitamins includes vitamins A, D, E, K, C, B1, B2, B3, B5, B6, B7, B12, and B9. Vitamin A includes esters containing acid chain lengths from C1-18. Vitamin E includes α-tocopherol, β-tocopherol, γ-tocopherol, δ-tocopherol, α-tocotrienol, β-tocotrienol, γ-tocotrienol and δ-tocotrienol.

There are 27 essential minerals for animals and those found in the diets in less than 100 ppm are considered micro or trace minerals (TMs). Generally, their levels in the diets will be measured in ppm, mg/kg or g/ton. In poultry species, the TMs that are supplemented are zinc (Zn), copper (Cu), manganese (Mn), iron (Fe), iodine, and selenium (Se). The supplemental TM sources can be inorganic salts or organic sources. Inorganic sources of TM generally are oxides, sulfates, and carbonates. There are different sources of organic trace minerals such as metal amino acid chelates, metal amino acid complexes, metal proteinates and metal polysaccharide complexes.

Examples of alpha-, beta-unsaturated compounds include 4-hydroxy-2-nonenal, 4-hydroxy-2-hexenal and 4-oxo-2-nonenal, cinnamic acid, cinnamyl alcohol and methyl cinnamate, o-methoxy cinnamaldehyde.

Examples of organic osmolytes include taurine, N-methyltaurine, hypotaurine, trimethylamine-N-oxide among others.

Examples of alcohols include C1-18, linear or branched, saturated or unsaturated, primary (e.g., butanol), secondary (e.g., sec-butyl alcohol) or tertiary (e.g., tert-butyl alcohol), cyclic or acyclic alcohols. Examples include propanol, butanol, hexanol, octanol, decanol, dodecanol, tetradecanol, coumaryl alcohol, coniferyl alcohol and sinapyl alcohol.

Examples of aldehydes include those with C1-18, linear or branched, saturated or unsaturated aldehydes. Examples include acetaldehyde, propionaldehyde, butyraldehyde, isobutyraldehyde, nonanal, cinnamaldehyde derivatives (e.g., p-coumaryl aldehyde, caffeic aldehyde, coniferyl aldehyde, and sinapaldehyde), and benzaldehyde derivatives (e.g., vanillin, isovanillin, syringaldehyde, cuminaldehyde, and 4-anisaldehyde).

Examples of metal oxides include zinc oxide and copper oxide.

Mixtures of active ingredients are also possible (e.g., 50 wt. % NaButyrate+25 wt. % NaPropionate+10 wt. percent or NaOAc; 60 wt. % NaBu+5% thymol+15% TBHQ+5% cinnamaldehyde).

Inert carriers can be combined with liquid active ingredients including corn cob, silica, clays (silicates), bentonite, diatomaceous earth, and kaolinite.

The present application discloses a granule comprising: (a) an outer layer comprising a cellulosic polymer; and (b) a solid core, comprising an active ingredient, wherein the granule has a diameter of from 50 microns to 1500 microns.

In one embodiment or in combination with any other embodiment, class, or subclass, the outer layer is 5-90 wt %, or 5-80 wt %, or 5-10 wt %, or 10 to 20 wt %, or 20 to 30 wt %, or 30 to 40 wt %, or 40 to 50w %, or 50 to 60 wt %, or 60-70 wt %, or 70-80 wt %, or 5-40 wt %, or 40-80 wt %, or 20-60 wt %, or 10-70 wt %, or 10-60 wt % of the total weight of the granule.

In one embodiment or in combination with any other embodiment, class, or subclass, the outer layer further comprises a polyvinyl alcohol. In one class of this embodiment, the polyvinyl alcohol is present at from 0.1 to 3 wt %, or from 0.1 to 2.5 wt %, or from 0.1 to 2.0 wt %, or from 0.1 to 1.5 wt %, or from 0.1 to 1.0 wt %, or from 0.1 to 0.9 wt %, or from 0.1 to 0.8 wt %, or from 0.1 to 0.7 wt %, or from 0.1 to 0.6 wt %, or from 0.1 to 0.5 wt %.

In one embodiment or in combination with any other embodiment, class, or subclass, the outer layer further comprises a plasticizer. In one class of this embodiment, the plasticizer is glycerol, a polyethylene glycol having a molecular weight from 200 to 600 daltons, a polyethylene glycol monomethyl ether having a molecular weight from 200 to 600 daltons, tri(C₂₋₈)alkanoyl citrate, di(C₂₋₈)alkanoyl monoglyceride, (C₁₋₈)alkylOC(O)(C₂₋₁₂)alkyleneC(O)O(C₁₋₆)alkyl, di(C₁₋₈)alkyl phthalate, (C₁₋₆)alkanoyl tri(C₂₋₈)alkyl citrate, polyvinylpyrrolidine, (C₁₀₋₂₀)alkanoic acid unsubstituted or substituted by 1 to 2 hydroxyl groups, (C₁₀₋₂₀)alkene carboxylic acid unsubstituted or substituted by 1 to 2 hydroxyl groups, castor oil, or tri(C₂₋₆)alkanoyl ester of glycerol.

In one embodiment or in combination with any other embodiment, class, or subclass, the outer layer further comprises a plasticizer. In one class of this embodiment or in combination with any other embodiment, class, or subclass, the plasticizer is glycerol, a polyethylene glycol having a molecular weight from 200 to 600 daltons, a polyethylene glycol monomethyl ether having a molecular weight from 200 to 600 daltons, tri(C₂₋₈)alkanoyl citrate, di(C₂₋₈)alkanoyl monoglyceride, (C₁₋₈)alkylOC(O)(C₂₋₁₂)alkyleneC(O)O(C₁₋₆)alkyl, di(C₁₋₈)alkyl phthalate, (C₁₋₆)alkanoyl tri(C₂₋₈)alkyl citrate, polyvinylpyrrolidine, (C₁₀₋₂₀)alkanoic acid unsubstituted or substituted by 1 to 2 hydroxyl groups, (C₁₀₋₂₀)alkene carboxylic acid unsubstituted or substituted by 1 to 2 hydroxyl groups, castor oil, or tri(C₂₋₆)alkanoyl ester of glycerol.

In one class of this embodiment or in combination with any other embodiment, class, or subclass, the plasticizer is triphenyl phosphate (TPP), tricresyl phosphate, cresyl phenyl phosphate, octyl diphenyl phosphate, diphenyl biphenyl phosphate, trioctyl phosphate, tributyl phosphate, diethyl phthalate, dimethoxyethyl phthalate, dimethyl phthalate, dioctyl phthalate, dibutyl phthalate, di-2-ethyl hexyl phthalate, butyl benzyl phthalate, di-2-ethylhexyl phthalate, butyl benzyl phthalate, dibenzyl phthalate, triethyl citrate, acetyl trimethyl citrate, acetyl tributyl citrate. methyl phthalyl methyl glycolate, ethyl phthalyl ethyl glycolate (EPEG), propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, octyl phthalyl ethyl glycolate, butyl oleate, methyl acetyl ricinolate, dibutyl sebacate, monoacetin, triacetin, monopropionin, tripropionin, monobutyrin, tributyrin, monolaurin, monocaprin, monocaprylin, monobenzoate, glycerol tribenzoate, glucose pentapropionate, glucose pentaisobutyrate, glucose pentatbutyrate, fructose pentapropionate, fructose pentaisobutyrate, fructose pentatbutyrate, xylose tetrapropionate, xylose tetraisobutyrate, xylose tetrabutryate, xylitol pentapropionate, xylitol pentaisobutryate, xylitol pentabutyrate, mannitol hexapropionate, mannitol hexaisobutyrate, mannitol hexabutyrate, glycerol, sorbitol, sorbitol sorbitan, polysorbate 80, oleic acid, ricinoleic acid, castor oil, acetyl triethyl citrate, ethyl heptanoate, methyl salicylate, ethyl salicylate, hexyl salicylate, citric acid, citric acid monohydrate, ethyl heptanoate, propylene carbonate, benzyl alcohol, benzyl benzoate, isopropyl myristate, or mixtures thereof.

In one embodiment or in combination with any other embodiment, class, or subclass, the outer layer comprises two or more layers, or three layers, or two layers, or one layer.

In one embodiment or in combination with any other embodiment, class, or subclass, the solid core is 25-95 wt %, or 10-60 wt %, or 10-50 wt %, or 10-40 wt %, or 10-30 wt %, or 30-95 wt %, or 40-95 wt %, or 50-95 wt %, or 10-70 wt %, or 10-75 wt %, or 20-60 wt %, or 30-60 wt %, based on the total weight of the granule.

In one embodiment or in combination with any other embodiment, class, or subclass, the solid core further comprises a carrier composition.

In one class of this embodiment, the carrier composition comprises one or more acceptable carriers or excipients.

The granules can have intermediate layer which can be a film coating to further protect and delay the release of the active ingredient from the solid core. The film can be a protein such as casein, a polysaccharide (e.g., a sugar or gelatin). The film can be crosslinked to optimize the physical and mechanical properties of the film to tune release of the active ingredient from the solid core. In one embodiment or in combination with any other embodiment, class, or subclass, the granule further comprises an intermediate layer disposed between the outer layer and the solid core. In one class of this embodiment or in combination with any other embodiment, class, or subclass, the intermediate layer is a film formed from a protein or a polysaccharide. In one subclass of this class, the polysaccharide is a sugar or gelatin. In one subclass of this class, the protein is casein.

In one embodiment or in combination with any other embodiment, class, or subclass, the cellulosic polymer is biodegradable. In one class of this embodiment or in combination with any other embodiment, class, or subclass, the cellulosic polymer is freshwater biodegradable.

In one embodiment or in combination with any other embodiment, class, or subclass, the cellulosic polymer is a cellulose esters, a cellulose ether, a chitosan, or a mixture thereof. In one class of this embodiment, the cellulose ester has a total degree of substitution that is from 1.1 to 2.5.

In one embodiment or in combination with any other embodiment, class, or subclass, the cellulosic polymer is a cellulose ester. In one class of this embodiment, the cellulose ester is a cellulose acetate, a cellulose acetate propionate, or a cellulose acetate butyrate. In one subclass of this class, the cellulose esters has a total degree of substitution that is from 1.1 to 2.5. In one subclass of this class, the cellulose esters has a total degree of substitution that is from 2.5 to 3.

In one embodiment or in combination with any other embodiment, class, or subclass, the cellulosic polymer is a cellulose ether. In one class of this embodiment or in combination with any other embodiment, class, or subclass, the cellulose ether is methyl cellulose, ethyl cellulose, hydroxyethyl cellulose, hydroxypropyl cellulose, hydroxypropylmethyl cellulose, carboxymethyl cellulose, or sodium carboxymethyl cellulose.

In one embodiment or in combination with any other embodiment, class, or subclass, the cellulosic polymer is a chitosan.

In one embodiment or in combination with any other embodiment, class, or subclass, the active ingredient is a liquid or a solid. In one class of this embodiment, the active ingredient is a liquid. When the active ingredient is a liquid, it can be formulated with a carrier. In one class of this embodiment, the active ingredient is a solid.

In one embodiment or in combination with any other embodiment, class, or subclass, the active ingredient is a small- or mid-chain fatty acid, an essential oil, a prebiotic, a probiotic, an enzyme, a hormone, an amino acid, a vitamin, a mineral, an analgesic, an antibiotic, an antiviral, a protein, an antibiotic, a bacteriophage, a nutrient, or an acceptable salt or ester thereof.

In one class of this embodiment, the small- or mid-chain fatty acid is formic acid, propionic acid, butyric acid, valeric acid, caproic acid, caprylic acid, capric acid, lauric acid, or an acceptable salt thereof.

In one embodiment or in combination with any other embodiment, class, or subclass, the granule releases at least 50 wt %, or at least 55 wt %, or at least 60 wt %, or at least 65 wt %, or at least 70 wt %, or at least 75 wt %, or at least 80 wt %, or at least 85 wt %, or at least 90 wt %, or at least 95 wt %, or at least 98 wt %, or at least 99 wt %, or 100 wt % of the active ingredient at 300 min, based on the total weight of the solid core, when subjected to the dissolution test method disclosed herein.

In one embodiment or in combination with any other embodiment, class, or subclass, the granule releases no more than 50 wt %, or no more than 45 wt %, or no more than 40 wt %, or no more than 35 wt %, or no more than 30 wt %, or no more than 25 wt %, or no more than 20 wt %, or no more than 15 wt %, or no more than 10 wt %, or no more than 9 wt %, or no more than 8 wt %, or no more than 7 wt %, or no more than 6 wt %, or no more than 5 wt %, or no more than 4 wt %, or no more than 1 wt %, or no more than 0.5 wt % of the active ingredient at 30 min, based on the total weight of the solid core, when subjected to the dissolution test method disclosed herein.

The present application discloses an animal feed comprising any one of the previously disclosed granules.

In one embodiment or in combination with any other embodiment, class, or subclass, the animal feed is an animal feed for a monogastric or ruminant animal.

In one embodiment or in combination with any other embodiment, class, or subclass, the animal feed is for swine, cows, goats, sheep, fish or poultry.

### EXAMPLES

### Abbreviations

CA is cellulose acetate; CAB is cellulose acetate butyrate; CaBu is calcium butyrate; CAP is cellulose acetate propionate; ChICI is choline chloride; EtAc is ethyl acetate; Ex is example(s); g is gram(s); L is liter(s); min is minute; mg is milligram(s); μm is micron(s) or micrometer(s); ml or mL is milliliter; NaAc is sodium acetate; NaBu is sodium butyrate; NaDMG is sodium dimethylglycine; NaPr is sodium propionate; CA-320S is Eastman™ Cellulose Acetate CA-320S; CA-398-10 is Eastman™ Cellulose Acetrate CA-398-10; CA-398-3 is Eastman™ Cellulose Acetrate CA-398-3; CA-398-30 is Eastman™ Cellulose Acetrate CA-398-30; CAP-504-0.2 is Eastman™ Cellulose Acetate Propionate CAP-504-0.2; CAP-482-20 is Eastman™ Cellulose Acetate Propionate CAP-504-20; CAP-504-0.4 is Eastman™ Cellulose Acetate Propionate CAP-504-0.4; PVOH is polyvinyl alcohol; EtOAc is ethyl acetate; CAB-551-0.01 is Eastman™ Cellulose Acetate Butyrate CAB-551-0.01; CAP-505-0.4 is Eastman™ Cellulose Acetate Propionate CAP-505-0.4;

ButiPEARL™ which is obtained from Kemin Industries is an encapsulated butyric acid. Chitosan (5-20 mPa·s, 0.5% in 0.5% acetic acid) product number C2395 was purchased from TCI. All Eastman cellulose esters were obtained from Eastman Chemical Company. Methyl cellulose (13-18 mPa·s 2% in water) was purchased from VWR chemical. Hydroxypropyl methyl cellulose (viscosity 40-60 CP, 2% in water at 20° C.) was purchased from Carbosynth. Sigma Aldrich supplied 2-hydroxethylcellulose (average Mv 90000), oleic acid technical grade 90%, triacetin 99%, and ethyl cellulose (48% ethoxyl basis). Alfa Aesar supplied glycerol tributyrate 98%, lecithin (refined powder). Sekisuki chemical supplied the polyvinyl alcohol E205S.

### Example 1. Cellulose Acetate Butyrate (Eastman CAB-381-0.5) Coated Choline Chloride Granules

Choline chloride granules with an average diameter of 500 to 800 μm were coated with CAB-381-0.5 having an acetyl, butyryl and hydroxyl content of 13.5%, 38% and 1.5% respectively. Coating was applied by fluidized bed technology using following methodology: (1) The Eastman CAB-381-0.5 is dissolved in a solution of EtAc. The total concentration of Eastman CAB 381-0.5 was 8 wt %. (2) ChCl granules are added to lab scale fluidized bed and fluidized by a heated nitrogen flow (0.2-0.3 m3/min). (3) The coating solution is sprayed onto the fluidized granule, which are individually coated until the desired coating weight is achieved. The spray rate onto the granules is about 1.5 grams/minute. The product temperature during the coating process was about 40° C. to 60° C. depending on the boiling point of the solvent system used.

A free-flowing product was obtained free from agglomerates. The coated granule contains ChCl (85.0 wt %) and no residual solvent.

### Example 2. Cellulose Acetate Butyrate (Eastman CAB Ensure 100) Coated NaDMG

NaDMG granules with an average diameter of about 300-700 μm were coated using Eastman's CAB Ensure 100. The coating was applied by a similar method as described in Ex 1. Free flowing coated granules were obtained containing 85% NaDMG and 15% by weight of the Eastman CAB Ensure 100 coating.

### Example 3. Cellulose Acetate Butyrate (Eastman Ensure 120) Coated NaAc Granules

NaAc granules with an average diameter of about 300-700 μm were coated using Eastman Ensure 120. The coating was applied by a similar method as described in Ex 1. Free flowing coated granules were obtained containing 85% NaAc and 15% by weight of the Eastman Ensure 120 coating.

### Example 4. Cellulose Acetate Butyrate (Eastman CAB-551-0.2) Coated NaBu Granules

NaBu granules with an average diameter of about 500-750 μm were coated with Eastman CAB 551-0.2 having an acetyl, butyrl and hydroxyl content of 2%, 52% and 2% respectively. The Eastman CAB-551-0.2 coating was applied as in Ex 1.

The coated granule product contained approximately 85% by weight of NaBu and 15% by weight of the CAB coating.

Table 1 provides additional coated granules made from various cellulosic coating compositions by adopt the procedure of Ex 1.

TABLE 1

| | | | Coating | |
|---|---|---|---|---|
| | | | Material on | |
| Ex | Coating | | final coated | |
| # | Material | Spray Soln | product (wt %) | Core Material |
| 5 | CA-320S | 7 wt % in Acetone | 22.5 | NaBu (500-750 μm) |
| 6 | CA-320S | 7 wt % in Acetone | 32.1 | NaBu (500-750 μm) |
| 7 | CA-320S | 7 wt % in Acetone | 41.3 | NaBu (500-750 μm) |
| 8 | CA-398-10 | 7 wt % in Acetone | 20.7 | NaBu (500-750 μm) |
| 9 | CA-398-3 | 7 wt % in Acetone | 24.6 | NaBu (500-750 μm) |
| 10 | CA-398- | 7 wt % in Acetone/water | 22.17 | NaBu (500-750 μm) |
| | 3/Oleic Acid | (80:20) | | |
| 11 | CA-398- | 7 wt % in Acetone/water | 21.7 | NaBu (500-750 μm) |
| | 3/Oleic Acid | (80:20) with PVOH (0.5 | | |
| | | wt % relative to total soln) | | |
| 12 | CA-398-3 | 7 wt % in Acetone/water | 24.6 | NaBu (500-750 μm) |
| | | (80:20) with PVOH (0.5 | | |
| | | wt % relative to total soln) | | |
| 13 | CA-398-3 | 7 wt % in Acetone/water | 31.9 | NaBu (500-750 μm) |
| | | (80:20) with PVOH (0.5 | | |
| | | wt % relative to total soln) | | |
| 14 | CA-398- | 7 wt % in Acetone/water | 21.4 | NaBu (500-750 μm) |
| | 3/triacetin | (80:20) with PVOH (0.5 | | |
| | | wt % relative to total soln) | | |
| 15 | CA-398- | 7 wt % in Acetone/water | 26.3 | NaBu (500-750 μm) |
| | 3/triacetin | (80:20) with PVOH (0.5 | | |
| | | wt % relative to total soln) | | |
| 16 | CA-398- | 7 wt % in Acetone/water | 21.1 | NaBu (500-750 μm) |
| | 3/tributyrin | (80:20) with PVOH (0.5 | | |
| | | wt % relative to total soln) | | |
| 17 | CA-398- | 7 wt % in Acetone/water | 34.7 | NaBu (500-750 μm) |
| | 3/tributyrin | (80:20) with PVOH (0.5 | | |
| | | wt % relative to total soln) | | |
| 18 | CA-398-30 | 7 wt % in Acetone | 26.9 | NaBu (500-750 μm) |
| 19 | CA-398-10 | 5 wt % in Acetone | 15 | NaDMG (500-700 μm) |
| 20 | CAP-504-0.2 | 8 wt % in EtAc | 15 | NaDMG (500-700 μm) |
| 21 | CAP-482-20 | 8 wt % in EtAc | 15.4 | NaBu (500-750 μm) |
| 22 | CAP-482-20 | 8 wt % in EtAc | 22.1 | NaBu (500-750 μm) |
| 23 | CAP-505-0.4 | 8 wt % in EtAc | 23.1 | NaBu (500-750 μm) |
| 24 | CAP-482-20 | 8 wt % in EtAc | 22.1 | NaBu (500-750 μm) |
| 25 | CAP-505-0.4 | 8 wt % in EtAc | 25.4 | NaBu (500-750 μm) |
| | (90 wt %)/Oleic | | | |
| | Acid (10 wt %) | | | |
| 26 | CAP-505-0.4 | 8 wt % in EtAc | 24.1 | NaBu (500-750 μm) |
| | (80 wt %)/ | | | |
| | Triacetin (20 | | | |
| | wt %) | | | |
| 27 | CAP-505-0.4 | 8 wt % in EtAc | 25.6 | NaBu (500-750 μm) |
| | (80 wt %)/ | | | |
| | Tributyrin (20 | | | |
| | wt %) | | | |
| 28 | CAP-505-0.4 | 8 wt % in EtAc with PVOH | 10 | Propyl Gallate |
| | | (0.5 wt % relative to total | | (300-700 μm) |
| | | soln) | | |
| 29 | CAP-505-0.4 | 8 wt % in EtAc with PVOH | 17.5 | Propyl Gallate |
| | | (0.5 wt % relative to total | | (300-700 μm) |
| | | wt of soln) | | |
| 30 | CAP-505-0.4 | 8 wt % in EtAc with PVOH | 9.7 | Ascorbic Acid |
| | | (0.5 wt % relative to total | | (250-500 μm) |
| | | wt of soln) | | |
| 31 | CAP-505-0.4 | 8 wt % in EtAc with PVOH | 29.4 | Ascorbic Acid |
| | | (0.5 wt % relative to total | | (250-500 μm) |
| | | wt of soln) | | |
| 32 | CAP-505-0.4 | 8 wt % in EtAc with PVOH | 17.5 | Methionine |
| | | (0.5 wt % relative to total | | (250-500 μm) |
| | | wt of soln) | | |
| 33 | CAP-505-0.4 | 8 wt % in EtAc with PVOH | 35.8 | Methionine |
| | | (0.5 wt % relative to total | | (250-500 μm) |
| | | wt of soln) | | |

### Examples 34-35

Coating an essential oil with CAP-505-0.4: Sixty-four grams of liquid eugenol oil was adsorbed into thirty six grams of feed-grade precipitated silica. CAP-505-0.4 was dissolved in pure EtAc containing 0.5 wt. % PVOH and the final concentration was 8 wt. %. The eugenol-loaded silica was added to a fluidized bed and the CAP-505-0.4 coating is applied as described in Ex 1. The final product had either 84.4 wt. % (Ex 34) or 80.0 wt. % (Ex 35) of the eugenol-silica material.

### Mixed CE Examples

The effects of mixing various cellulose esters on the release of sodium butyrate are shown in the next few examples. The use of a pure cellulose acetate coatings may result in a premature release of sodium butyrate in the upper part of the GI tract. The release of sodium butyrate from a pure cellulose-acetate-propionate or cellulose-acetate-butyrate coatings is slowed compared to the cellulose-acetate coatings. Combinations of various cellulose esters allow for a more sustained release of sodium butyrate while also minimizing the cost of the mixed cellulose ester coatings by incorporating some fraction of cellulose acetate into the mixed esters.

Combination of CA-398-3 with CAP-505-0.4: Cellulose ester solutions with two cellulose esters were prepared by taking an appropriate weight parts of the two cellulose esters and dissolving in a solution containing 80% acetone and 20% water. These cellulose ester solutions were sprayed onto NaBu granules until the desired coating weight percent was achieved. Table 2 shows the materials made.

TABLE 2

| | | | Wt % of | |
|---|---|---|---|---|
| | | | Coating | |
| | | | Material on | |
| Ex | Coating | | final coated | Core |
| # | Material | Spray Soln | product | Material |
| 36 | CA-398-3/CAP- | 7 wt % in Acetone/Water (80:20) | 15.5 | NaBu (500- |
| | 505-0.4 (25:75) | | | 750 μm) |
| 37 | CA-398-3/CAP- | 7 wt % in Acetone/Water (80:20) | 29.6 | NaBu (500- |
| | 505-0.4 (25:75) | | | 750 μm) |
| 38 | CA-398-3/CAP- | 7 wt % in Acetone/Water (80:20) | 16.1 | NaBu (500- |
| | 505-0.4 (50:50) | | | 750 μm) |
| 39 | CA-398-3/CAP- | 7 wt % in Acetone/Water (80:20) | 29.1 | NaBu (500- |
| | 505-0.4 (50:50) | | | 750 μm) |
| 40 | CA-398-3/CAP- | 7 wt % in Acetone/Water (80:20) | 17.0 | NaBu (500- |
| | 505-0.4 (75:25) | | | 750 μm) |
| 41 | CA-398-3/CAP- | 7 wt % in Acetone/Water (80:20) | 30.0 | NaBu (500- |
| | 505-0.4 (75:25) | | | 750 μm) |
| 42 | CA-398-3/CAP- | 7 wt % in Acetone/Water (80:20) | 29.9 | NaBu (500- |
| | 505-0.4 (50:50) | | | 750 μm) |
| 43 | CA-398-3/CAP- | 7 wt % in Acetone/Water (80:20) | 29.6 | NaBu (500- |
| | 505-0.4 (25:75) | | | 750 μm) |
| 44 | CA-398-3/CAB- | 7 wt % in Acetone/Water (80:20) | 17.3 | NaBu (500- |
| | 551-0.01 (50:50) | | | 750 μm) |
| 45 | CA-398-3/CAB- | 7 wt % in Acetone/Water (80:20) | 29.1 | NaBu (500- |
| | 505-0.4 (50:50) | | | 750 μm) |
| 46 | CAP-505- | 7 wt % in Acetone/Water (80:20) | 29.4 | NaBu (500- |
| | 0.4/CAB-551- | | | 750 μm) |
| | 0.01 (50:50) | | | |

### Chitosan

### Example 47

Chitosan coated sodium butyrate: Chitosan was dissolved in 2% acetic acid, so the chitosan concentration was 4 weight percent. The viscosity of this 4 wt. % solution was 170 mPa·s. NaBu granules with an average diameter of about 500-750 μm are coated with the chitosan solution. The coated granule contains approximately 75 weight percent NaBu and had no residual solvent.

### Cellulose Ethers

The coating of NaBu particles with cellulose ethers were performed by adapting the procedure for the preparation of Ex 1. Cellulose ether free-flowing products were obtained free from agglomerates. The coated granules contain approximately 75 wt. % NaBu and no residual solvent. Table 3 provides the cellulose ether coated examples.

TABLE 3

| | | | Wt % of | |
|---|---|---|---|---|
| | | | Coating | |
| | | | Material on | |
| Ex | Coating | | final coated | Core |
| # | Material | Spray Soln | product | Material |
| 48 | Methyl cellulose | 5 wt % in Water | 22.7 | NaBu (500- |
| | | | | 750 μm) |
| 49 | Ethyl cellulose | 7 wt % in EtAc | 23.5 | NaBu (500- |
| | | | | 750 μm) |
| 50 | Ethyl cellulose | 7 wt % in EtAc | 37.5 | NaBu (500- |
| | | | | 750 μm) |
| 51 | 2-hydroxyethyl | 5 wt % in Water | 23.3 | NaBu (500- |
| | cellulose | | | 750 μm) |
| 52 | 2-hydroxypropyl | 4 wt % in Water with PVOH (0.5 | 26.2 | NaBu (500- |
| | cellulose | wt % relative to total soln) | | 750 μm) |
| 53 | Ethyl | 7 wt % in EtAc | 18.8 | NaBu (500- |
| | cellulose/oleic | | | 750 μm) |
| | acid/PEG400 | | | |
| | (83.9:15.6:0.5) | | | |
| 54 | Ethyl cellulose/ | 7 wt % in EtAc | 15.7 | NaBu (500- |
| | Triacetin/PEG400 | | | 750 μm) |
| | (96.4:3.1:0.5) | | | |
| 55 | Ethyl cellulose/ | 7 wt % in EtAc | 20 | NaBu (500- |
| | Tributryin/PEG400 | | | 750 μm) |
| | (83.9:3.9:0.5) | | | |

### Dissolution Test Method

The release profiles of the active ingredients were determined by an in vitro model consisting of two solutions simulated gastric and intestinal fluid. The gastric fluid is composed of an aqueous HCl solution with pH of 1.9 and contains pepsin (2000 U/mL). Approximately 2 g of coated products is added to 200 mL of replicated gastric solution under mild agitation (100 rpm) and 38° C. Based on literature, a residence time of 45 min in the gastric solution is used. After 45 min, pH is increased to 5.9 with a phosphate buffer to replicate the intestinal fluid. Further, several other substances are added, namely pancreatin (2 mg/L), lecithin (0.5 g/L), arabic gum (1 g/L) and bile extract (2.0 g/L). Based on literature, 255 min residence time in the intestinal fluid was used. During the entire process, samples are taken at specific time intervals from either the gastric or intestinal fluid. Samples are analyzed by an internal HPLC method to quantify the amount of Al released.

The Ex 1-4 Al release profiles were compared to commercial fat-coated butyrate (FCB) samples. The time of 300 min is chosen to simulate the residence time along the gastrointestinal tract of broiler chickens. The gastric portion of this GI tract is about 50 min and lower portion of the GI tract extends from about 50 min to 300 min.

Table 4 shows that Ex 1-4 exhibited less than 50 wt % release within the first 30 mins, but at least 80 wt % release at 300 min.

TABLE 4

| | Release Amount (wt %) | | | | | | | | | |
|---|---|---|---|---|---|---|---|---|---|---|
| | Gastric Fluid | | | | | Intestinal Fluid | | | | |
| | 0 | 5 | 10 | 15 | 30 | 60 | 120 | 180 | 240 | 300 |
| Ex # | min | min | min | min | min | min | min | min | min | min |
| Buti-PEARL | 0 | — | 28.5 | 34.4 | 43.2 | 57.3 | 61.2 | 57.2 | 57.5 | 60.0 |
| FCB-1-CA-Bu | 0 | — | — | 34.4 | 43.2 | 57.3 | 61.2 | — | 57.5 | 60 |
| Commercial | 0 | — | — | 57.2 | 68.9 | 75.2 | 79.8 | — | 92.0 | 95.0 |
| Fat Coated | | | | | | | | | | |
| NaBu | | | | | | | | | | |
| 1 | 0 | 6.6 | — | 28.6 | 47.4 | 66.6 | 78.1 | — | 88.7 | 90.4 |
| 2 | 0 | — | — | 7.5 | 25.6 | 51.1 | 70.5 | — | 78.1 | 81.8 |
| 3 | 0 | 2.1 | — | 7.5 | 16.7 | 40.8 | 68.2 | — | 91.2 | 95.4 |
| 4 | 0 | — | 3.3 | 12.9 | 26.8 | 46.9 | 71.7 | 87.8 | 93.3 | — |
| 5 | 0 | 62.9 | — | 95.4 | 97.3 | 99.4 | 98.0 | — | 96.1 | 100.0 |
| 6 | 0 | 17.4 | — | 88.8 | 95.9 | 96.6 | 98.4 | — | 99.7 | 100.0 |
| 7 | 0 | 5.0 | — | 56.5 | 86.6 | 97.5 | 99.6 | — | 100.0 | 100.0 |
| 8 | 0 | 5.5 | — | 39.7 | 68.0 | 86.9 | 95.1 | — | 100.0 | 99.7 |
| 9 | 0 | 6.2 | — | 36.8 | 68.0 | 86.9 | 95.1 | — | 100.0 | 99.7 |
| 10 | 0 | 0.3 | — | 0.6 | 11.0 | 71.9 | 93.1 | — | 98.8 | 99.9 |
| 11 | 0 | 7.2 | — | 23.5 | 46.3 | 74.5 | 100.0 | — | 100.0 | 100.0 |
| 12 | 0 | 6.2 | — | 36.8 | 68.0 | 86.9 | 95.1 | — | 100 | 99.7 |
| 13 | 0 | 3.0 | — | 19.5 | 47.3 | 78.1 | 92.6 | — | 99.1 | 100.0 |
| 14 | 0 | 0.3 | — | 6.8 | 50.1 | 86.5 | 96.7 | — | 99.5 | 100.0 |
| 15 | 0 | 0 | — | 0.5 | 5.6 | 48.6 | 82.9 | — | 94.9 | 95.7 |
| 16 | 0 | 0 | — | 0.3 | 3.2 | 32.8 | 75.9 | — | 94.0 | 97.2 |
| 17 | 0 | 0 | — | 0 | 0.2 | 4.9 | 43.2 | — | 84.3 | 91.4 |
| 18 | 0 | 10.7 | — | 42.7 | 67.5 | 88.1 | 96.2 | — | 100.0 | 99.7 |
| 19 | 0 | 69.7 | — | 93.2 | 98.3 | 96.8 | 96.0 | — | 97.4 | 98.2 |
| 20 | 0 | 14.4 | — | 34.1 | 62.4 | 86.2 | 95.5 | — | 99.0 | 100.0 |
| 21 | 0 | 2.6 | — | 9.3 | 24.1 | 54.1 | 79.5 | — | 89.5 | 95.8 |
| 22 | 0 | 2.6 | — | 1.9 | 6.2 | 22.6 | 54.3 | — | 74.9 | 81.3 |
| 23 | 0 | 2.3 | — | 8.2 | 21.4 | 49.7 | 76.7 | — | 91.9 | 95.1 |
| 24 | 0 | 2.6 | — | 1.9 | 6.2 | 22.6 | 54.3 | — | 74.9 | 81.3 |
| 25 | 0 | 1.7 | — | 4.3 | 9.8 | 25.6 | 52.6 | — | 77.1 | 86.1 |
| 26 | 0 | 0.2 | — | 1.9 | 11.1 | 37.1 | 69.7 | — | 89.2 | 93.0 |
| 27 | 0 | 0 | — | 0.3 | 4.7 | 23.4 | 54.9 | — | 79.6 | 85.2 |
| 28 | 0 | 40.1 | — | 68.2 | 84.0 | 78.3 | 86.9 | — | 91.8 | 93.4 |
| 29 | 0 | 2.4 | — | 9.7 | 23.9 | 34.4 | 43.7 | — | 46.2 | 50.2 |
| 30 | 0 | 33.6 | — | 48.9 | 74.8 | 93.8 | 99.4 | — | 99.9 | 100.0 |
| 31 | 0 | 2.8 | — | 12.4 | 31.7 | 58.0 | 87.6 | — | 96.5 | 100.0 |
| 32 | 0 | 10.4 | | 16.4 | 29.5 | 45.9 | 64.0 | — | 78.2 | 86.2 |
| 33 | 0 | 1.2 | — | 4.9 | 12.2 | 23.0 | 40.8 | — | 56.4 | 70.8 |
| 34 | 0 | 19.2 | — | 33.4 | 53.9 | 54.8 | 63.7 | — | 69.1 | 78.7 |
| 35 | 0 | 23.2 | — | 39.1 | 51.7 | 51.7 | 51.2 | — | 51.9 | 56.3 |
| 36 | 0 | 0.8 | — | 18.6 | 42.8 | 72.2 | 90.0 | — | 96.4 | 97.9 |
| 37 | 0 | 0 | — | 0.5 | 12.3 | 38.8 | 64.8 | — | 87.2 | 91.3 |
| 38 | 0 | 4.5 | — | 29.9 | 62.1 | 84.0 | 91.7 | — | 95.8 | 98.1 |
| 39 | 0 | 0 | — | 2.3 | 16.7 | 46.0 | 73.8 | — | 87.1 | 89.7 |
| 40 | 0 | 1.6 | — | 27.3 | 64.2 | 86.6 | 96.1 | — | 100.0 | 99.8 |
| 41 | 0 | 0 | — | 1.2 | 18.3 | 52.4 | 77.5 | — | 91.2 | 93.6 |
| 42 | 0 | 0 | — | 2.3 | 16.7 | 46.0 | 73.8 | — | 87.1 | 89.7 |
| 43 | 0 | 0 | — | 0.5 | 12.3 | 38.8 | 64.8 | — | 87.2 | 91.3 |
| 44 | 0 | 0.3 | — | 3.3 | 14.2 | 40.4 | 69.5 | — | 85.2 | 89.7 |
| 45 | 0 | 0.4 | — | 1.6 | 4.4 | 16.7 | 42.8 | — | 70.8 | 77.6 |
| 46 | 0 | 0 | — | 0 | 0 | 8.8 | 32.3 | — | 64.4 | 69.6 |
| 47 | 0 | 68.4 | — | 93.7 | 97.0 | 99.2 | 99.4 | — | 98.1 | 100.0 |
| 48 | 0 | 89.9 | — | 93.2 | 93.8 | 95.9 | 96.5 | — | 94.7 | 100.0 |
| 49 | 0 | 1.9 | — | 2.9 | 5.8 | 17.3 | 47.8 | — | 72.5 | 81.0 |
| 50 | 0 | 2.6 | — | 4.0 | 5.4 | 9.8 | 27.3 | — | 59.4 | 65.9 |
| 51 | 0 | 97.4 | — | 98.0 | 98.5 | 99.4 | 97.0 | — | 98.9 | 100.0 |
| 52 | 0 | 79.8 | — | 91.3 | 96.4 | 98.3 | 98.9 | — | 99.8 | 100.0 |
| 53 | 0 | 0 | — | 2.1 | 8.1 | 25.2 | 56.1 | — | 83.6 | 90.0 |
| 54 | 0 | 0.9 | — | 4.7 | 16.0 | 40.0 | 68.0 | — | 85.0 | 88.1 |
| 55 | 0 | 0.4 | — | 1.6 | 5.1 | 20.5 | 50.5 | — | 74.5 | 81.4 |

1. A granule comprising:
(a) an outer layer comprising a cellulosic polymer; and
(b) a solid core, comprising an active ingredient,
wherein the granule has a diameter of from 50 microns to 1500 microns.

2. The granule of claim 1, wherein the outer layer is 5-80 wt % of the total weight of the granule.

3. The granule of claim 1, wherein the solid core is 25-95 wt % or 10-75 wt % of the total weight of the granule.

4. The granule of claim 1, wherein the outer layer comprises two or more layers.

5. The granule of claim 1, wherein the granule further comprises an intermediate layer disposed between the outer layer and the solid core.

6. The granule of claim 1, wherein the cellulosic polymer is biodegradable.

7. The granule of claim 1, wherein the cellulosic polymer is a cellulose ester having a total degree of substitution that is from 1.1 to 2.5, a cellulose ether, a chitosan, or a mixture thereof.

8. The granule of claim 7, wherein the cellulose ester is a cellulose acetate, a cellulose acetate propionate, or a cellulose acetate butyrate.

9. The granule of claim 1, wherein the outer layer further comprises 0.1 to 2 wt % of polyvinyl alcohol.

10. The granule of claim 1, wherein the outer layer further comprises a plasticizer

11. The granule of claim 1, wherein the solid core further comprises a carrier composition.

12. The granule of claim 11, wherein the carrier composition comprises one or more acceptable carriers or excipients.

13. The granule of claim 1, wherein the active ingredient is a liquid or a solid.

14. The granule of claim 1, wherein the active ingredient is an small, mid or long-chain fatty acid or their salts, mono, di, tri or polyesters, enzymes, amino acids, amine derivatives, methylated glycine derivatives, synthetic or natural antioxidants, phenolic or nonphenolic antioxidants, pigments or colorants, essential oils containing terpenes, vitamins, trace minerals, alpha or beta unsaturated compounds, organic osmolytes, alcohols, aldehydes, a metal oxide, a prebiotic, a probiotic, an enzyme, a hormone, a mineral, an analgesic, an antibiotic, an antiviral, a protein, an antibiotic, a bacteriophage, a nutrient, or an acceptable salt or ester thereof.

15. The granule of claim 14, wherein the active ingredient is a small- or mid-chain fatty acid or a pharmaceutically or nutritionally acceptable salt thereof.

16. The granule of claim 15, wherein the small- or mid-chain fatty acid is formic acid, propionic acid, butyric acid, valeric acid, lauric acid, or an acceptable salt thereof.

17. The granule of claim 1, wherein the granule releases at least 50 wt % of the active ingredient at 300 min, based on the total weight of the solid core, when subjected to the dissolution method test method disclosed in the specification.

18. The granule of claim 1, wherein the granule releases no more than 50 wt % of the active ingredient at 30 min, based on the total weight of the solid core, when subjected to the dissolution method test method disclosed in the specification.

19. An animal feed comprising the granule of claim 1.

20. The animal feed of claim 19, wherein the animal feed is an animal feed for a monogastric or ruminant animal.

21. The granule of claim 1, wherein the outer layer is 10-60 wt % of the total weight of the granule.
